(19) United States
(12) Patent Application Publication
(10) Pub. No.: US 2009/0090121 A1
(43) Pub. Date: Apr. 9, 2009

(54) Refrigerator Unit and/or Freezer Unit

(76) Inventors: Josef Hecht, Erlenmoos (DE); Jorg Huber, Ochsenhausen (DE); Hans Gross, Neu-Ulm (DE); Franz Kauk, Kisslegg (DE); Gunter Mack, Hochdorf (DE); Matthias Wiest, Hattenburg (DE)

Correspondence Address: DILWORTH & BARRESE, LLP, 333 EARLE OVINGTON BLVD., SUITE 702, UNIONDALE, NY, 11553, US

(21) Appl. No.: 11/918,288

(22) PCT Filed: Apr. 12, 2006
(86) PCT No.: PCT/EP2006/003395

§ 371 Date: Oct. 11, 2007

(30) Foreign Application Priority Data
Apr. 12, 2005 (DE) 20 2005 005 865.3
Apr. 14, 2005 (DE) 10 2005 032 976.4

(51) Int. Cl. F25D 19/00; F25B 30/02; F25D 27/00; B23P 19/04

(52) U.S. Cl. 62/298; 62/515; 62/264; 29/700

(57) ABSTRACT

The present invention relates to a refrigerator unit and/or a freezer unit comprising a cooling tank, which includes an inner tank having a refrigerated space, and an evaporator. The present invention furthermore relates to a method of installing a refrigerator unit and/or freezer unit in which an evaporator as well as at least one further electrical and/or technical cooling functional component are inserted in an inner tank of the refrigerator unit and/or freezer unit and are fastened to an inner tank wall. Installing the various electrical and technical cooling components after one another individually at different positions of the inner tank of the unit and individually connecting them to the outwardly disposed electronics of the unit is avoided with the present invention. Already installing individual components before the foaming of the unit tank is in particular also avoided, whereby the housing handling is considerably facilitated. In accordance with the invention, at least a substantial part of the electrical and technical cooling components, in particular the evaporator, the evaporator sensor and the refrigerated space sensor, is pre-installed at a common installation plate which is then inserted into the inner tank together with the pre-installed components and can be installed there. The pre-installation of the components on the installation plate can take place in a favorable working position. The installation steps at the unit tank, and thus in an unfavorable working position, are minimized.

The present invention relates to a refrigerator unit and/or a freezer unit comprising a cooling tank, which includes an inner tank having a refrigerated space, and an evaporator. The present invention furthermore relates to a method of installing a refrigerator unit and/or freezer unit in which an evaporator as well as at least one further electrical and/or technical cooling functional component are used in an inner tank of the refrigerator unit and/or freezer unit and are fastened to an inner tank wall.

As a rule, a plurality of electrical and technical cooling components such as evaporators, temperature sensors, lighting means or fans are installed and, on the presence of a cold storage compartment, further temperature control components such as cold storage compartment sensors, heating elements or a cold storage compartment lighting are installed at various positions in the refrigerated space of refrigerator units and/or freezer units so that a considerable installation effort arises. For example, as a rule, the refrigerated space sensor is installed in the light housing of the refrigerated space lighting and they are then installed together at a side wall of the inner wall so that the supply cables of the light and of the sensor have to be guided outwardly and have to be plugged to the electronics. On the other hand, the evaporator is fastened to the rear wall of the inner tank with the evaporator sensor pre-installed thereon, with the cable of the evaporator sensor likewise having to be guided outwardly through the rear wall and having to be plugged to the electronics. Finally, where present, the fan and the temperature control means and the lighting means for the cold storage compartment have to be installed and the corresponding cables have to be guided outwardly and plugged to the electronics. All this together results in an installation effort which is considerable in part and which is moreover increased in that individual components are pre-installed prior to the foaming, whereby the handling of the housing before and after the foaming is made considerably more difficult. Installation work must moreover sometimes be carried out in an unfavorable working position.

It is therefore the object of the present invention to provide an improved refrigerator unit and/or a freezer unit of the initially named kind as well as an improved method for the installation of such a refrigerator unit and/or a freezer unit which avoids the disadvantages of the prior art and further develops the latter in an advantageous manner. A simple installation should preferably be achieved to facilitate handling of the unit housing before and after the foaming and to avoid installation work in unfavorable working positions.

This object is solved in accordance with the invention by a refrigerator unit and/or a freezer unit in accordance with claim 1. In a technical method respect, the named object is solved by a method in accordance with claim 10. Preferred configurations of the invention are the subject of the dependent claims.

Installing the various electrical and technical cooling components after one another individually at different positions of the inner tank of the unit and individually connecting them to the outwardly disposed electronics of the unit is avoided with the present invention. Already installing individual components before the foaming of the unit tank is in particular also avoided, whereby the housing handling is considerably facilitated. In accordance with the invention, at least a substantial part of the electrical and technical cooling components, in particular the evaporator, the evaporator sensor and the refrigerated space sensor, is pre-installed at a common installation plate which is then inserted into the inner tank together with the pre-installed components and can be installed there. The pre-installation of the components on the installation plate can take place in a favorable working position. The installation steps at the unit tank, and thus in an unfavorable working position, are minimized.

In a further development of the invention, in addition to the aforesaid components of evaporators, evaporator sensors and refrigerated space sensors on the installation plate, the further electrical and technical cooling components to be positioned in the refrigerated space can also be pre-installed, such as in particular a fan and a refrigerated space lighting.

The use of the installation plate and the combination of the electrical and technical cooling components thereon as a pre-installed unit is in particular of advantage with a refrigerator unit and/or a freezer unit comprising an additional cold storage compartment. In this case, the components of the temperature control device for the control or setting of the temperature in the cold storage compartment can also advantageously be pre-installed on the installation plate, namely in particular a cold storage compartment sensor, a cold storage compartment heating element and/or a valve for the control or setting of the cold storage compartment temperature, and optionally also a cold storage compartment lighting.

In accordance with a particularly advantageous embodiment of the invention, the electrical connection leads of the components combined on the installation plate are combined at a common electrical connector, in particular at a single electrical plug connector. Only one single electrical connector hereby has to be connected on the installation of the installation plate into the interior of the cooling tank. A correspondingly prepared cable loom or cable set having a single electrical connector is preferably pre-installed in the cooling tank so that on the installation of the aforesaid installation plate only the plug connector provided thereon has to be connected to the plug connector which is on the cooling tank side and which is connected via the aforesaid cable loom to the control electronics of the unit which can provided on the outer side of the unit in a manner known per se.

In a corresponding manner, the refrigerant tubing of all components conducting refrigerant which, if several are present, are combined on the installation plate, can be combined to form a common supply connector and a common discharge connector. Only two refrigerant tube connectors hereby have to be connected on the installation of the installation plate. Here, too, the refrigerant tube connectors on the tank side are advantageously pre-installed at a suitable point.

To achieve a minimal final installation effort, in accordance with an embodiment of the invention, all the electrical and technical cooling components to be provided in the inner tank can be pre-installed on the installation plate and can be installed together with it in the inner tank. Differing from this maximum solution, however, considerable savings in the installation effort can also be achieved if at least a substantial part of these components is combined on the installation plate, while individual electrical or technical cooling components are installed separately.

In a further development of the invention, the installation plate forms an inner wall of the cooling tank bounding the refrigerated space in the installed state. It can in particular form the vertical rear wall of the refrigerated space.

The invention will be explained in more detail in the following with respect to a preferred embodiment and to associated drawings. There are shown in the drawing:

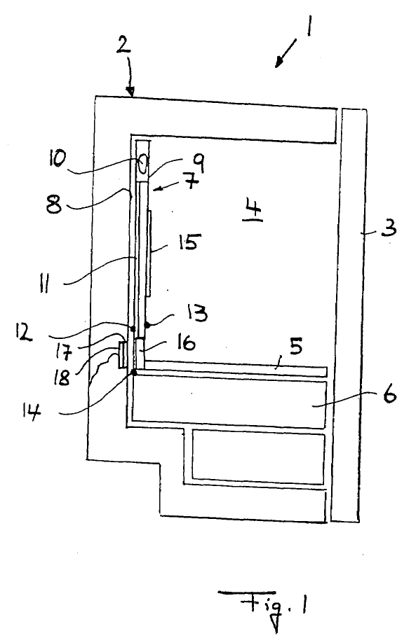

FIG. 1: a schematic cross-sectional view of a refrigerator unit having a cold storage compartment in accordance with a preferred embodiment of the invention.

The refrigerator unit 1 shown in FIG. 1 includes a cooling tank 2 which can be closed by a door 3. A refrigerated space 4 as well as a cold storage compartment 6 beneath it and separated by the tray 5 are provided in the interior of the cooling tank 2.

An installation plate 9 is provided at the rear wall 7 of the inner tank 8 of the cooling tank 2 in the form of a vertical dividing wall at which various electrical and technical cooling components of the refrigerator unit 1 are pre-installed. In the embodiment drawn, these are a fan 10, an evaporator 11, an evaporator sensor 12 provided at the surface of the evaporator 11, a refrigerated space temperature sensor 13, a cold storage compartment temperature sensor 14, a refrigerated space lighting 15 as well as, optionally, a cold storage compartment lighting.

The following procedure is followed in the installation: First, the fan 10, the evaporator 11, all the temperature sensors 12, 13 and 14, the refrigerated space lighting 15, optionally the cold storage compartment lighting and the valve 16 for the control of the temperature in the cold storage compartment 6 are pre-installed on the installation plate 9. The installation plate 9 is naturally removed from the inner space of the cooling tank for this purpose. The pre-assembly can take place at a suitable position, optionally also at an external location, with the installation plate 9 as such being able to be handled easily and, for example being able to be stored on an installation table or an installation belt or being able to be held in an otherwise suitable manner.

The electrical connector cables of the electrical components pre-installed on the installation plate 9 are advantageously all combined to form a common plug connector 17 which is likewise pre-installed on the installation plate 9, in particular on its rear side.

The cooling tank 2 is then prepared for the installation of the pre-installed installation plate 9. A prepared cable loom or cable set is in particular installed into the housing of the refrigerator unit 1, in particular attached to the rear wall 7, with one plug position for all electrical components. The corresponding connectors of the plug connector are connected to the electronics provided at the outer side of the unit via the cable loom.

In the final installation, the fully pre-installed installation plate 9 is then inserted into the inner tank 8, as FIG. 1 shows, and is fixed there, for example by screws. Moreover, the plug connector 17 on the installation plate side is connected to the pre-installed plug connector 18 on the tank side. The refrigerant supply connector and the refrigerant drainage connector of the pre-installed evaporator 14 are connected to connectors likewise prepared on the tank side.

1. A refrigerator unit and/or a freezer unit comprising a cooling tank (2), which includes an inner tank (8) having a refrigerated space (4), and an evaporator (11), wherein the evaporator (11), together with at least one further electrical and/or technical cooling functional component (10, 12, 13, 14, 15), is preinstalled at an installation plate (9) which can be inserted into the inner tank (8) together with the preinstalled components and can be installed there.

2. A refrigerator unit and/or a freezer unit in accordance with claim 1, wherein the evaporator sensor (12), the refrigerated space sensor (13), further sensors, a fan (10) and/or lighting means (15) can be pre-installed at the installation plate (9).

3. A refrigerator unit and/or a freezer unit in accordance with claim 1, wherein the inner tank (8) includes a cold storage compartment (6) in addition to the refrigerated space (4) and a temperature control device, in particular a cold storage compartment sensor (14), a cold storage compartment heating element and/or a valve for the control or setting of the temperature in the cold storage compartment (6), can be pre-installed at the installation plate (9).

4. A refrigerator unit and/or a freezer unit in accordance with claim 3, wherein cold storage compartment lighting means can furthermore be pre-installed at the installation plate (9).

5. A refrigerator unit and/or a freezer unit in accordance with claim 1, wherein the electrical connector leads of a plurality of electrical components (10, 12, 13, 14, 15), in particular all of them, which can be pre-installed on the installation plate (9), are combined at a common electrical connector, in particular at a single plug connector (17) connected to the installation plate (9).

6. A refrigerator unit and/or a freezer unit in accordance with claim 1, wherein the refrigerant tubing of all components (11) which conduct refrigerant and which are pre-installed on the installation plate (9) are combined at a common supply connector and/or a common discharge connector.

7. A refrigerator unit and/or a freezer unit in accordance with claim 1, wherein all the electronic and/or technical cooling components arranged in or at the inner tank can be pre-installed on the installation plate (9).

8. A refrigerator unit and/or a freezer unit in accordance with claim 1, wherein the installation plate (9) forms an inner wall bounding the refrigerated space (4), in particular a vertical rear wall (7) of the cooling tank (2), in the installed state.

9. A refrigerator unit and/or a freezer unit in accordance with claim 1, wherein the evaporator (11) and/or the at least one further functional part (10, 12, 13, 14, 15) is connected to the installation plate (9) by foaming.

10. A method for the installation of a refrigerator unit and/or freezer unit, comprising steps of
inserting an evaporator (11) and at least one further electronic and/or technical cooling functional component (10, 12, 13, 14, 15) in an inner tank (8) of the refrigerator unit and/or freezer unit and fastening to an inner tank wall,
in a first step, pre-installing the evaporator (11) and the further functional component (10, 12, 13, 14, 15) on an installation plate (9) outside the inner tank and,
in a second step, then inserting the installation plate (9) together with the components pre-installed thereon into the inner tank (8) and installing.

11. A method in accordance with claim 1, wherein, in the first step, an evaporator sensor (12), a refrigerated space sensor (13), further sensors, a fan (10) and/or lighting means (15) are pre-installed on the installation plate (9) in addition to the evaporator (11).

12. A refrigerator unit and/or a freezer unit in accordance with claim 2, wherein the inner tank (8) includes a cold storage compartment (6) in addition to the refrigerated space (4) and a temperature control device, in particular a cold storage compartment sensor (14), a cold storage compartment heating element and/or a valve for the control or setting of the temperature in the cold storage compartment (6), can be pre-installed at the installation plate (9).

13. A refrigerator unit and/or a freezer unit in accordance with claim 12, wherein cold storage compartment lighting means can furthermore be pre-installed at the installation plate (9).

14. A refrigerator unit and/or a freezer unit in accordance with claim 13, wherein the electrical connector leads of a plurality of electrical components (10, 12, 13, 14, 15), in particular all of them, which can be pre-installed on the installation plate (9), are combined at a common electrical connector, in particular at a single plug connector (17) connected to the installation plate (9).

15. A refrigerator unit and/or a freezer unit in accordance with claim 12, wherein the electrical connector leads of a plurality of electrical components (10, 12, 13, 14, 15), in particular all of them, which can be pre-installed on the installation plate (9), are combined at a common electrical connector, in particular at a single plug connector (17) connected to the installation plate (9).

16. A refrigerator unit and/or a freezer unit in accordance with claim 4, wherein the electrical connector leads of a plurality of electrical components (10, 12, 13, 14, 15), in particular all of them, which can be pre-installed on the installation plate (9), are combined at a common electrical connector, in particular at a single plug connector (17) connected to the installation plate (9).

17. A refrigerator unit and/or a freezer unit in accordance with claim 3, wherein the electrical connector leads of a plurality of electrical components (10, 12, 13, 14, 15), in particular all of them, which can be pre-installed on the installation plate (9), are combined at a common electrical connector, in particular at a single plug connector (17) connected to the installation plate (9).

18. A refrigerator unit and/or a freezer unit in accordance with claim 2, wherein the electrical connector leads of a plurality of electrical components (10, 12, 13, 14, 15), in particular all of them, which can be pre-installed on the installation plate (9), are combined at a common electrical connector, in particular at a single plug connector (17) connected to the installation plate (9).

19. A refrigerator unit and/or a freezer unit in accordance with claim 14, wherein the refrigerant tubing of all components (11) which conduct refrigerant and which are pre-installed on the installation plate (9) are combined at a common supply connector and/or a common discharge connector.

20. A refrigerator unit and/or a freezer unit in accordance with claim 15, wherein the refrigerant tubing of all components (11) which conduct refrigerant and which are pre-installed on the installation plate (9) are combined at a common supply connector and/or a common discharge connector.
